(19) United States
(12) Patent Application Publication
(10) Pub. No.: US 2007/0190374 A1
(43) Pub. Date: Aug. 16, 2007

(54) CARBON MONOXIDE TRANSFORMING APPARATUS FOR FUEL CELL AND FUEL CELL POWER GENERATING SYSTEM

(76) Inventors: Makoto HARADA, Yokohama-shi (JP); Masato Yoshino, Yokohama-shi (JP); Katsuya Wada, Yokohama-shi (JP); Junji Koetsuka, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/691,866

(22) Filed: Mar. 27, 2007

Related U.S. Application Data
(63) Continuation of application No. 10/832,284, filed on Apr. 27, 2004.
Application No. 10/832,284 is a division of application No. 09/684,776, filed on Oct. 10, 2000, now abandoned.
Application No. 09/684,776 is a continuation of application No. PCT/JP00/00716, filed on Feb. 9, 2000.

(30) Foreign Application Priority Data
Feb. 10, 1999 (JP) 11-032454

(51) Int. Cl. H01M 8/06; B01J 8/02

(52) U.S. Cl. 429/19; 422/211

(57) ABSTRACT

A carbon monoxide transforming apparatus for fuel cell is constructed such that a catalyst having at least platinum or palladium carried on a carrier which has a base point on the surface thereof is filled in a reaction vessel having gas inlet and outlet ports. As a result, a transformation and start-up operation can be instantaneously performed on the occasion of transforming a gas containing, as main components, hydrogen, carbon monoxide, carbon dioxide and water vapor so as to convert the carbon monoxide into carbon dioxide and at the same time to generate hydrogen. Additionally, the operating temperature for the transformation can be expanded.

### CROSS REFERENCE TO RELATED APPLICATIONS

This is a Continuation of Application No. PCT/JP00/00716, filed Feb. 9, 2000.

This application is based upon and claims the benefit of priority from the prior Japanese Patent Application No. 11-032454, filed Feb. 10, 1999, the entire contents of which are incorporated herein by reference.

### BACKGROUND OF THE INVENTION

This invention relates to a carbon monoxide transforming apparatus for fuel cell, and to a fuel cell power generating system incorporated with the transforming apparatus.

In recent years, a fuel cell such as a phosphoric acid type fuel cell, a solid polymer type fuel cell, etc. has been put to practical use and is still being studied and developed. This fuel cell is designed such that hydrogen (or a gas containing hydrogen) is supplied to a fuel electrode, and oxygen (a gas containing oxygen such for example as air) is supplied to an oxidizing electrode to allow an electrochemical reaction to take place between hydrogen and oxygen, thereby generating electric power.

In this case however, pure hydrogen to be generally supplied to the fuel electrode is not used in view of saving cost. Namely, hydrocarbons such as natural gas, town gas or propane gas are exclusively employed for the source of hydrogen. It is also proposed to employ, as a raw fuel, alcohols such as methanol instead of using hydrocarbons such as natural gas, town gas or propane gas. In this case, the alcohols are converted through steam reformation or partial oxidation with oxygen (or air) by making use of a reformer into a hydrogen-rich reformed gas to be employed as a raw gas for the fuel electrode.

The aforementioned reformed gas is composed of hydrogen as a main component, and by-products such as carbon dioxide, carbon monoxide and water vapor. Among these by-products, carbon monoxide acts to obstruct the electrochemical reaction between hydrogen and oxygen in the fuel cell. Under the circumstances, there has been practiced to reduce the quantity of carbon monoxide and at the same time, to treat carbon monoxide in a carbon monoxide transforming apparatus so as to generate hydrogen as much as possible.

According to this transforming apparatus, carbon monoxide (CO) and water vapor are allowed to react with each other as indicated by the following formula (1) to convert (transform) them into hydrogen and carbon dioxide, thereby making it possible to reduce the quantity of carbon monoxide in the reformed gas to not more than 1% in general.
CO+H₂O→CO₂+H₂ (1)

This reaction is a exothermic reaction, so that the equilibrium of reaction tends to be shifted toward right side as the temperature becomes lower, thereby reducing the concentration of CO, but making the reaction rate slower, thus necessitating to make the reactor larger.

Meanwhile, there is known as one of the conventional carbon monoxide transforming apparatus a kind having a structure wherein the reaction vessel having gas inlet and outlet ports is filled with a catalyst composed mainly of copper-zinc oxide-alumina as a so-called low temperature shift catalyst (Cu—ZnO type low temperature shift catalyst). This catalyst is disclosed in “CATALYST HANDBOOK” SECOND EDITION Edited by Martyn V. Twigg Wolfe Publishing Ltd., 1989, pp. 309-315, Table 6.9 (page 313). This catalyst is highly active even if the temperature is relatively low. Namely, this catalyst can be generally used at a temperature of 200 to 250° C., the quantity thereof required for generating a power of 1 kW in the fuel cell being approximately 1 liter, to reduce the concentration of CO to not more than 0.5%.

Since this catalyst functions so as to utilize the copper as an originating point for developing the activity thereof, it is well known that the activity of the catalyst depends largely on the specific surface area of the copper. Therefore, the copper is required to be dispersed as very fine particles in the catalyst. However, due to this microstructure of the catalyst, if the catalyst is employed under a high temperature condition, the sintering of the catalyst tends to occur, thus deteriorating the catalyst. For example, if the catalyst is used at a temperature of 270° C. or more for a long period of time, the catalytic activity of the catalyst would be deteriorated, thus shortening the life of the catalyst. As described above, the transformation reaction of carbon monoxide is an exothermal reaction, and hence, as the reaction proceeds, the temperature of the layer of catalyst is caused to rise. Therefore, whenever the aforementioned Cu—ZnO type low temperature shift catalyst is employed, a cooling system is frequently attached to the carbon monoxide transforming apparatus.

The carbon monoxide transforming apparatus employing the aforementioned Cu—ZnO type low temperature shift catalyst is generally employed as a large scale hydrogen manufacturing apparatus in chemical industries and an excellent performance thereof has been demonstrated. This excellent performance of the carbon monoxide transforming apparatus in chemical industries can be attributed to the fact that the start-up/stoppage of the apparatus is rarely needed and therefore the steady operation thereof is generally taken place in chemical industries, i.e. an excessive load fluctuation is given to the catalyst.

Whereas, in the case of the fuel cell power generating system, the start-up/stoppage of the apparatus is caused to frequently take place, and therefore, a quick response to load fluctuation on the catalyst is demanded. In particular, when a fuel cell is to be mounted on a vehicle as in the case of a solid polymer type fuel cell, it is expected that the start-up/stoppage would be frequently taken place and hence the load fluctuation would be intensified. Moreover, since the fuel cell power generating system is not of closed system, the intrusion more or less of the external atmosphere into the system may be inevitably caused to take place on the occasion of stoppage. As explained above, in the fuel cell power generating system, the influence to be imposed on the catalyst differs prominently from, i.e. more severe than that to be experienced in the application thereof to chemical industries.

There is also a problem in the aforementioned carbon monoxide transforming apparatus for fuel cell that since the aforementioned copper-zinc oxide-based catalyst is oxidized in air atmosphere at room temperature, the reduction of the catalyst is required at the time of start-up, thereby making it difficult to realize a quick (preferably, instantaneous) start-up, and therefore, the heat resistance of the catalyst is also required to be improved.

### BRIEF SUMMARY OF THE INVENTION

The present invention is to provide a carbon monoxide transforming apparatus for fuel cell, which is capable of instantaneously performing a transformation and start-up operation on the occasion of transforming a gas containing, as main components, hydrogen, carbon monoxide, carbon dioxide and water vapor so as to convert the carbon monoxide into carbon dioxide and at the same time to generate hydrogen, and also capable of operating it at an expanded range of temperature.

The present invention is also to provide a fuel cell power generating system provided with a transforming apparatus which is capable of instantaneously performing a transformation and start-up operation on the occasion of transforming a gas containing, as main components, hydrogen, carbon monoxide, carbon dioxide and water vapor so as to convert the carbon monoxide into carbon dioxide and at the same time to generate hydrogen, and also capable of operating it at an expanded range of temperature, thereby enabling the fuel cell power generating system to be effectively and instantaneously operated by preventing an electrochemical reaction between hydrogen and oxygen from being obstructed by the carbon monoxide.

Namely, this invention provides a carbon monoxide transforming apparatus for fuel cell, which comprises:

a reaction vessel having gas inlet and outlet ports; and

a catalyst filled in the reaction vessel and having at least platinum or palladium carried on a carrier which has a base point on the surface thereof.

In the carbon monoxide transforming apparatus for fuel cell according to this invention, it is preferable that the catalyst is constructed such that the carrier having a base point on the surface thereof is formed of titanium oxide, and that platinum is carried on the carrier.

In the carbon monoxide transforming apparatus for fuel cell according to this invention, it is preferable that the catalyst is constructed such that the carrier having a base point on the surface thereof is formed of titanium oxide, and that platinum and a rare earth element are carried on the carrier. In this case, the rare earth element should preferably be at least one element selected from the group consisting of lanthanum and cerium. Preferably, the platinum and a rare earth element are carried on the titanium oxide carrier at a ratio of 0.1 to 3% by weight and 0.3 to 3% by weight, respectively.

In the carbon monoxide transforming apparatus for fuel cell according to this invention, it is preferable that the catalyst is constructed such that the carrier having a base point on the surface thereof is formed of zinc oxide, and that platinum is carried on the carrier.

In the carbon monoxide transforming apparatus for fuel cell according to this invention, it is preferable that the catalyst is constructed such that the carrier having a base point on the surface thereof is formed of iron oxide, and that platinum and a rare earth element are carried on the carrier. In this case, the rare earth element should preferably be at least one element selected from the group consisting of lanthanum and cerium. Preferably, the platinum and a rare earth element are carried on the iron oxide carrier at a ratio of 0.5 to 5% by weight and 1 to 3% by weight, respectively.

The carbon monoxide transforming apparatus for fuel cell according to this invention may further comprises a cooling coil for cooling the catalyst, the cooling coil being disposed inside the reaction vessel.

In the carbon monoxide transforming apparatus for fuel cell according to this invention, it is preferable that the reaction vessel is partitioned by means of a plurality of gas-permeating plates into plural sections which are arranged between the gas inlet port and the gas outlet port, each section housing a catalyst or a cooling coil, which are alternately arranged.

This invention also provides a fuel cell power generating system comprising:

a reformer for converting a raw fuel into a hydrogen-rich reformed gas;

a carbon monoxide transforming apparatus comprising a reaction vessel having gas inlet and outlet ports, and a catalyst filled in the reaction vessel and having at least platinum or palladium carried on a carrier which has a base point on the surface thereof; and

a fuel cell having a fuel electrode into which a transformed gas is introduced from the transforming apparatus.

In the fuel cell power generating system, in particular, the fuel cell power generating system using town gas or natural gas as a raw fuel according to this invention, it is preferable that a desulfurizer is further disposed on an upstream side of the reformer.

In the fuel cell power generating system according to this invention, it is also preferable that a selective oxidizing means for carbon monoxide is further disposed between the reformer and the fuel cell.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic flow diagram illustrating a fuel cell power generating system according to this invention;

FIG. 2 shows one embodiment of the carbon monoxide transforming apparatus to be incorporated into the fuel cell power generating system of FIG. 1;

FIG. 3 shows another embodiment of the carbon monoxide transforming apparatus to be incorporated into the fuel cell power generating system of FIG. 1;

FIG. 4 shows still another embodiment of the carbon monoxide transforming apparatus to be incorporated into the fuel cell power generating system of FIG. 1;

FIG. 5 is a graph illustrating the relationship between the starting time of the carbon monoxide transforming apparatus and the conversion ratio of carbon monoxide (CO) in Example 8 of this invention and in Comparative Example 3; and

FIG. 6 is a graph illustrating the relationship between the reaction time of carbon monoxide with water vapor and the reaction rate constant in the carbon monoxide transforming apparatus of Examples 9 and 10 of this invention and of Comparative Example 4.

### DETAILED DESCRIPTION OF THE INVENTION

Various embodiments of the fuel cell power generating system according to this invention will be explained in details with reference to the drawings as follows.

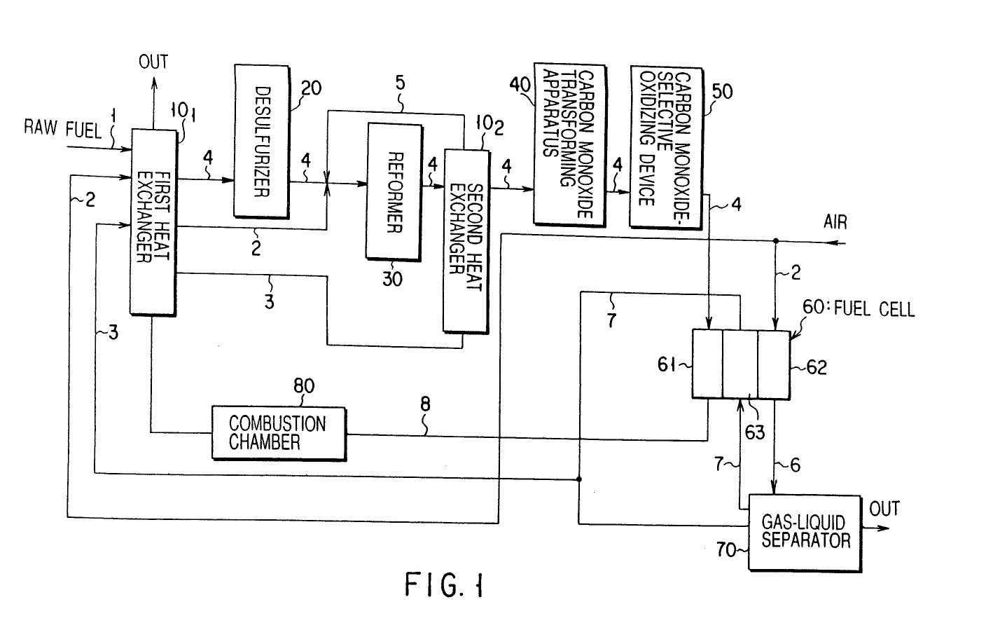

FIG. 1 shows a fuel cell power generating system incorporated with, as a fuel cell, a solid polymer type fuel cell for instance.

A first heat exchanger 10₁, a desulfurizer 20, a reformer 30, a second heat exchanger 10₂, a carbon monoxide transforming apparatus 40, a carbon monoxide-selective oxidizing device 50 and a solid polymer type fuel cell 60 are successively linked via a piping 4 to each other.

The desulfurizer 20 may be a device which is designed to remove a sulfur compound gas such as hydrogen sulfide, methylmercaptan, t-butylmercaptan, etc. by making use of active carbon; a hydrogenating/desulfurizing device provided with Pt—Pd/alumina type catalyst on a first stage and with ZnO (adsorbent) on a second stage for removing a sulfur compound gas; or a deep desulfurizing device wherein a low temperature separation technique is adopted.

The reformer 30 is designed to reform a raw fuel that has passed through the desulfurizer 20 into a hydrogen-rich gas. As for this reformer 30, it is possible to employ a device whose reaction vessel having gas inlet and outlet ports is filled with a nickel-based catalyst, a platinum-based catalyst or a ruthenium-based catalyst for enabling a reforming reaction to take place by making use of water vapor; or a device whose reaction vessel having gas inlet and outlet ports is filled with a platinum-based catalyst, a ruthenium-based catalyst, a palladium-based catalyst or a nickel-based catalyst for enabling a partial oxidation reaction to take place therein.

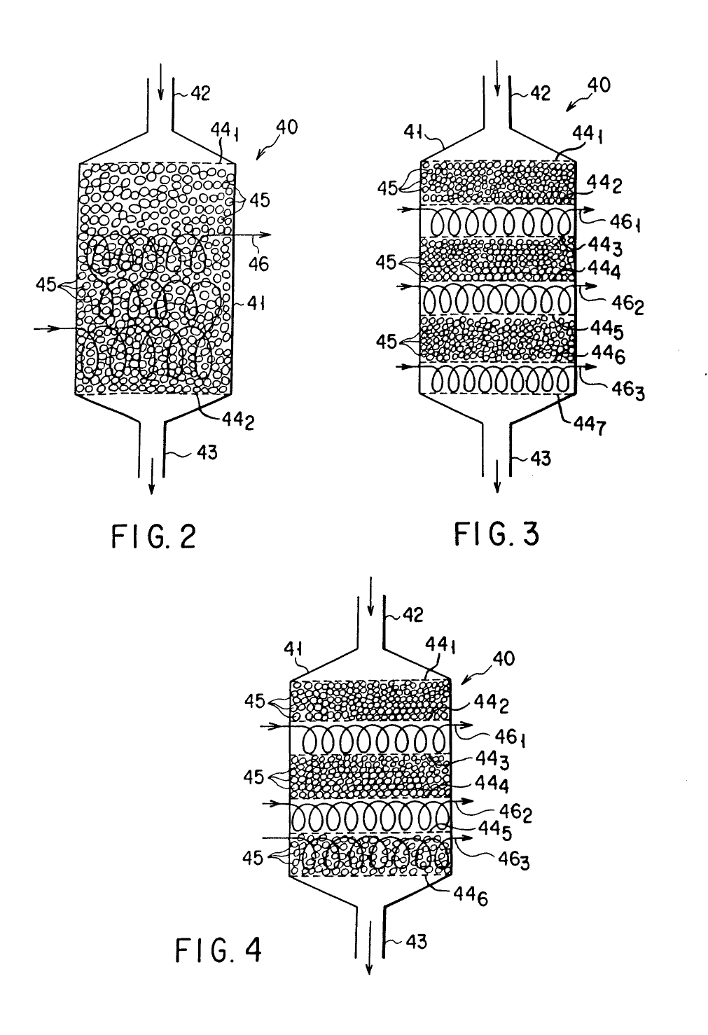

The carbon monoxide transforming apparatus 40 may be constructed as shown in FIG. 2, FIG. 3 or FIG. 4.

In the carbon monoxide transforming apparatus 40 shown in FIG. 2, the reaction vessel 41 has a gas-feeding pipe 42 at an upper portion thereof and a gas-discharging pipe 43 at a lower portion thereof. A couple of gas-permeating plates, e.g. a couple of perforated plates 441 and 442 are horizontally disposed inside the reaction vessel 41, i.e. in the vicinity of the gas-feeding pipe 42 and of the gas-discharging pipe 43, respectively, thereby defining the reaction space of the reaction vessel 41. A granular catalyst 45 for instance is filled in a space of the reaction vessel 41 defined between the perforated plates 44₁ and 44₂. A cooling coil 46 is disposed inside the reaction vessel 41, allowing a cooling medium to pass through the cooling coil 46 so as to prevent the rise in temperature of the catalyst that may be caused by the reaction (exothermic reaction) of the catalyst 45. A cooling water (about 70° C.) for the main body of fuel cell to be explained below can be utilized as this cooling medium. The cooling rate of the catalyst by means of this cooling coil 46 can be controlled by adjusting the temperature or flow rate of the cooling medium.

In the carbon monoxide transforming apparatus 40 shown in FIG. 3, the reaction vessel 41 has a gas-feeding pipe 42 at an upper portion thereof and a gas-discharging pipe 43 at a lower portion thereof. Seven gas-permeating plates, e.g. seven perforated plates-44₁ to 44₇ are horizontally disposed inside the reaction vessel 41, i.e. arrayed side by side at desired intervals between the vicinity of the gas-feeding pipe 42 and the vicinity of the gas-discharging pipe 43, thereby partitioning the reaction space of the reaction vessel 41. A granular catalyst 45 for instance is filled in each space of the reaction vessel 41 defined between the perforated plates 44₁ and 44₂, between the perforated plates 44₃ and 44₄ and between the perforated plates 44₅ and 44₆. Three pieces of cooling coils 46₁ to 46₃ are respectively disposed in each space of the reaction vessel 41 defined between the perforated plates 44₂ and 44₃, between the perforated plates 44₄ and 44₅ and between the perforated plates 44₆ and 44₇, i.e. in a space immediately below the space where the catalyst 45 is filled. A cooling medium is allowed to pass through each of the cooling coils 46₁ to 46₃ so as to prevent the rise in temperature of the catalyst that may be caused by the reaction (exothermic reaction) of the catalyst 45. A cooling water (about 70° C.) for the main body of fuel cell to be explained below can be utilized as this cooling medium. The cooling rate of the catalyst by means of these cooling coils 46₁, 46₂ and 46₃ can be controlled by adjusting the temperature or flow rate of the cooling medium.

In the carbon monoxide transforming apparatus 40 shown in FIG. 4, the reaction vessel 41 has a gas-feeding pipe 42 at an upper portion thereof and a gas-discharging pipe 43 at a lower portion thereof. Six gas-permeating plates, e.g. six perforated plates 44₁ to 44₆ are horizontally disposed inside the reaction vessel 41, i.e. arrayed side by side at desired intervals between the vicinity of the gas-feeding pipe 42 and the vicinity of the gas-discharging pipe 43, thereby partitioning the reaction space of the reaction vessel 41. A granular catalyst 45 for instance is filled in each space of the reaction vessel 41 defined between the perforated plates 44₁ and 44₂, between the perforated plates 44₃ and 44₄ and between the perforated plates 44₅ and 44₆. Three pieces of cooling coils 46₁ to 46₃ are respectively disposed in each space of the reaction vessel 41 defined between the perforated plates 44₂ and 44₃, between the perforated plates 44₄ and 44₅ and between the perforated plates 44₅ and 44₆ wherein the catalyst 45 is filled. A cooling medium is allowed to pass through each of the cooling coils 46₁ to 46₃ so as to prevent the rise in temperature of the catalyst that may be caused by the reaction (exothermic reaction) of the catalyst 45. A cooling water (about 70° C.) for the main body of fuel cell to be explained below can be utilized as this cooling medium. The cooling rate of the catalyst by means of these cooling coils 46₁ to 46₃ can be controlled by adjusting the temperature or flow rate of the cooling medium.

As for the carbon monoxide-selective oxidizing device 50, it is possible to employ a device whose reaction vessel having gas inlet and outlet ports is filled with a carbon monoxide-selective oxidizing catalyst of Pt/alumina type, Ru/alumina type, Pt—Ru/alumina type or Pt/zeolite type.

According to this fuel cell system shown in FIG. 1, a raw fuel such as town gas is introduced via the piping 1 into the first heat exchanger 10₁ to thereby preheat the raw fuel. The resultant preheated raw fuel is then introduced into the desulfurizer 20 to remove sulfur moieties in the raw fuel, after which the raw fuel is introduced into the reformer 30. As for the raw fuel to be employed in this case, it is possible to employ, for example, hydrocarbons such as natural gas, town gas and propane gas; or alcohols such as methanol. Where hydrocarbons such as propane gas or alcohols such as methanol are employed as a raw fuel however, the aforementioned desulfurizer 20 can be omitted.

Air is introduced via the piping 2 into the first heat exchanger 10₁ to thereby preheat the air. Then, the resultant preheated air is introduced via the piping 2 into a piping 4 interposed between the desulfurizer 20 and the reformer 30, and then introduced into the reformer 30.

Water is introduced via the piping 3 into the first heat exchanger 10₁ and then introduced via the piping 3 into the second heat exchanger 10₂, thereby allowing the water to be heated to become water vapor as it passes through these first and second heat exchangers 10₁ and 10₂. Then, the resultant water vapor is introduced via a by-pass piping 5 into the piping 4 which is interposed between the desulfurizer 20 and the reformer 30, and then introduced via this piping 4 into the reformer 30.

The pre-heated raw fuel, the pre-heated air and water vapor that have been introduced into the reformer 30 are then converted into a reformed gas containing hydrogen as a main component and also carbon monoxide, carbon dioxide, water vapor and nitrogen as by-products.

The reformed gas is then allowed to cool down to a predetermined temperature as it passes through the second heat exchanger 10₂. The reformed gas thus cooled is then introduced from a gas-feeding pipe 42 of the carbon monoxide transforming apparatus 40 constructed for instance as shown in FIG. 2 into the reaction vessel 41 filled with the catalyst 45, thereby allowing the carbon monoxide and water vapor contained in the reformed gas to react with each other according to the aforementioned formula (1) and converting them into hydrogen and carbon dioxide. As a result, the concentration of carbon monoxide can be reduced down to 1% for instance, the magnitude of decrease in concentration being dependent on the outlet temperature of the gas at the discharge pipe 43 of the reaction vessel 41.

The transformed gas containing hydrogen, carbon dioxide and residual carbon monoxide is then introduced into the carbon monoxide-selective oxidizing device 50 filled with a predetermined selective oxidizing catalyst, thereby enabling the residual carbon monoxide to be oxidized and converted into carbon dioxide (reducing the concentration of carbon monoxide down to about 50 ppm or less). The resultant gas containing hydrogen, carbon dioxide and a reduced concentration of carbon monoxide is then introduced into the fuel electrode 61 of fuel cell 60. Concurrently, air is introduced via the piping 2 into the oxidizing agent electrode 62 of fuel cell 60, thus allowing the power generation to take place.

The water generated at the oxidizing agent electrode 62 of fuel cell 60 is introduced together with exhaust air into a gas-liquid separator 70 through a piping 6, thereby allowing the water to be separated, the exhaust air being discharged as it is. The water thus separated by the gas-liquid separator 70 is recycled via a circulating piping 7, thereby allowing it to be used at the cooling section 63 as a cooling water for cooling the fuel cell 60. Further, a portion of the separated water is utilized, through the circulating piping 7 and the piping 3 constituting the water supply line, as a water vapor for the reformation of carbon monoxide. Since a combustible moieties such as unutilized hydrogen, etc. are left remained in the exhaust gas of the fuel electrode 61, the exhaust gas is transferred via a piping 8 to a combustion chamber 80 and allowed to burn therein. The combustion gas thus generated is then introduced into the first heat exchanger 10₁, thus enabling it to be utilized as a heating source for pre-heating the raw fuel, etc, the combustion gas being subsequently discharged into air atmosphere.

As for the catalyst to be employed in the carbon monoxide transforming apparatus 40 shown in FIG. 2, FIG. 3 or FIG. 4, it is possible to employ those having a granular, pellet-like or honeycomb structure wherein at least platinum or palladium is carried on a carrier having a base point on the solid surface thereof. As for the carrier having a base point on the solid surface thereof, it is possible to employ titanium oxide, zirconium oxide, zinc oxide, iron oxide, magnesium oxide, etc. In particular, catalysts comprising a combination of the carriers to be explained below and platinum or palladium (metals to be carried on a carrier) are preferable among them. (1) Platinum/titanium oxide-based catalyst

This catalyst is constructed such that platinum is carried on a carrier consisting of titanium oxide. The ratio of platinum carried on the carrier is preferably in the range of 0.1 to 3% by weight based on the weight of the carrier. If the ratio of platinum carried on the carrier is less than 0.1% by weight, it would become difficult to obtain a catalyst having an excellent catalytic activity. On the other hand, if the ratio of platinum carried on the carrier is more than 3% by weight, it would not only become difficult to further enhance the catalytic activity, but also invite an increase in cost by an increased quantity of the noble metal.

(2) Platinum-rare Earth Element/titanium Oxide-based Catalyst

This catalyst is constructed such that platinum and a rare earth element are carried on a carrier consisting of titanium oxide. Due to a synergistic effect by the incorporation of rare earth element functioning as a promoter, this catalyst is enabled to exhibit a further excellent catalytic activity. Among the rare earth elements, lanthanum and cerium are especially effective due to the prominent effect to be derived therefrom.

The ratios of platinum and of rare earth elements carried on the carrier are preferably in the range of 0.1 to 3% by weight and in the range of 0.3 to 3% by weight, respectively, based on the weight of the titanium oxide carrier. If the ratio of platinum carried on the carrier is less than 0.1% by weight, it would become difficult to obtain a catalyst having an excellent catalytic activity. On the other hand, if the ratio of platinum carried on the carrier is more than 3% by weight, it would not only become difficult to further enhance the catalytic activity, but also invite an increase in cost by an increased quantity of the noble metal. If the ratio of rare earth elements carried on the carrier is less than 0.3% by weight, it would become difficult to sufficiently exhibit the effect of incorporating rare earth elements. On the other hand, if the ratio of rare earth elements carried on the carrier is more than 3% by weight, it would not only become difficult to further enhance the activity of the promoter, but also invite an increase in cost by an increased quantity thereof.

(3) Palladium/titanium oxide-based catalyst

This catalyst is constructed such that palladium is carried on a carrier consisting of titanium oxide. The ratio of palladium carried on the carrier is preferably in the range of 0.8 to 8% by weight based on the weight of the carrier. If the ratio of palladium carried on the carrier is less than 0.8% by weight, it would become difficult to obtain a catalyst having an excellent catalytic activity. On the other hand, if the ratio of palladium carried on the carrier is more than 8% by weight, it would not only become difficult to further enhance the catalytic activity, but also invite an increase in cost by an increased quantity of the noble metal.

(4) Palladium/zinc oxide-based catalyst

This catalyst is constructed such that palladium is carried on a carrier consisting of zinc oxide. The ratio of palladium carried on the carrier is preferably in the range of 0.8 to 8% by weight based on the weight of the carrier because of the same reasons as explained in the above item (3).

(5) Palladium-rare Earth Element/iron Oxide-based Catalyst

This catalyst is constructed such that palladium and a rare earth element are carried on a carrier consisting of iron oxide. Due to a synergistic effect by the incorporation of rare earth element functioning as a promoter, this catalyst is enabled to exhibit a further excellent catalytic activity. Among the rare earth elements, lanthanum and cerium are especially effective due to the prominent effect to be derived therefrom.

The ratios of palladium and of rare earth elements carried on the carrier are preferably in the range of 0.5 to 5% by weight and in the range of 1 to 3% by weight, respectively, based on the weight of the iron oxide carrier. If the ratio of palladium carried on the carrier is less than 0.5% by weight, it would become difficult to obtain a catalyst having an excellent catalytic activity. On the other hand, if the ratio of palladium carried on the carrier is more than 5% by weight, it would not only become difficult to further enhance the catalytic activity, but also invite an increase in cost by an increased quantity of the noble metal. If the ratio of rare earth elements carried on the carrier is less than 1% by weight, it would become difficult to sufficiently exhibit the effect of incorporating rare earth elements. On the other hand, if the ratio of rare earth elements carried on the carrier is more than 3% by weight, it would not only become difficult to further enhance the activity of the promoter, but also invite an increase in cost by an increased quantity thereof.

The catalysts of the aforementioned items (1) to (5) can be manufactured by the methods as explained below.

First of all, a raw powder selected from titanium oxide powder, zinc oxide powder and iron oxide powder is charged, together with a binder comprising a hydrocarbon, into a granulating machine to granulate the mixture into a spherical porous body, thereby manufacturing a carrier. Then, an aqueous solution of platinic chloride (when the metal to be carried is formed of platinum), an aqueous solution of palladium chloride (when the metal to be carried is formed of palladium) or an aqueous solution of nitrate of rare earth element is impregnated into the aforementioned carrier, dried at a predetermined temperature (for example, about 120° C.), and sintered in air atmosphere at a temperature in the range of 300 to 500° C. Thereafter, the resultant body is subjected to a reduction treatment for 3 to 4 hours in a reducing atmosphere containing hydrogen at a temperature in the range of 300 to 500° C., thereby manufacturing a catalyst.

By the way, when a catalyst containing a rare earth element as a metal to be carried thereon is to be manufactured, an aqueous solution of nitrate of rare earth element should preferably be impregnated in predetermined quantity into the aforementioned carrier prior to the impregnation of an aqueous solution of platinic chloride or an aqueous solution of palladium chloride into the carrier.

The aforementioned fuel cell 60 can be applied not only to a solid polymer type fuel cell but also to a phosphoric acid type fuel cell.

According to the carbon monoxide transforming apparatus of this invention which has been explained above, when a reformed gas heated to 300° C. for example and containing hydrogen as a main component, and by-products such as carbon dioxide, carbon monoxide and water vapor is introduced from the gas-feeding pipe 42 into the reaction vessel 41 as shown in FIG. 2, the reformed gas is allowed to contact with the catalyst 45 filled in the reaction vessel 41, thereby allowing the carbon monoxide (CO) and water vapor in the reformed gas to be reacted with each other to convert them into hydrogen and carbon dioxide. When a carrier having a base point on the surface thereof and carrying at least platinum or palladium thereon is employed as the catalyst in this reaction, the catalyst can be prevented or inhibited from being oxidized which might be caused due to the exposure thereof to air atmosphere. As a result, the purging operation by means of inert gas or reducing operation of the catalyst can be omitted, thus making it possible to instantaneously execute the start-up for the transformation operation.

Further, since the aforementioned catalyst has a heat resistance of not less than 100° C., the operation temperature thereof can be expanded. This catalyst can be hardly deteriorated even if it is operated at a temperature of 300° C. for instance and is capable of maintaining its excellent catalytic activity for a long period of time.

The catalysts of the aforementioned items (1) to (5) can be hardly oxidized in air atmosphere, enabling them to exhibit excellent stability and further excellent heat resistance and to maintain excellent catalytic activity for a very long period of time. Among them, the aforementioned platinum-rare earth element/titanium oxide-based catalyst carrying a rare earth element as a promoter is capable of maintaining its very excellent catalytic activity for a long period of time.

Therefore, according to this invention, the concentration of carbon monoxide can be effectively minimized by means of the reaction (transformation reaction) between carbon monoxide and water vapor for a long period of time, and it is possible to realize a carbon monoxide transformation apparatus which is capable of executing instantaneous start-up.

Since the aforementioned reaction in the carbon monoxide transformation apparatus accompanies the generation of heat, the temperature of the apparatus is caused to rise in the middle of reaction. However, it is possible in this case to cool the apparatus by disposing the cooling coils 46, 46₁, 46₂ and 46₃ for passing a cooling medium therethrough inside the reaction vessel 41 as shown in FIGS. 2, 3 and 4. As a result, the temperature of catalyst disposed inside the reaction vessel 41 can be lowered to a temperature which is suited for the reaction, thereby enabling the concentration of carbon monoxide to be reduced to about 5%, enabling the life of catalyst to improve, and also enabling the temperature of gas being discharged from the outlet port of the discharge pipe 43 of reaction vessel 41 to be lowered to not more than 250° C. for instance.

In particular, since, as shown in FIG. 3, seven perforated plates 44₁ to 44₇ are horizontally disposed inside the reaction vessel 41, i.e. arrayed side by side at desired intervals between the vicinity of the gas-feeding pipe 42 and the vicinity of the gas-discharging pipe 43, thereby partitioning the reaction space of the reaction vessel 41, and additionally, since granular catalyst 45 and three pieces of cooling coils 46₁ to 46₃ are alternately arranged along the space between the gas-feeding pipe 42 and the gas-discharging pipe 43, it is possible to realize an effective transforming reaction between carbon monoxide and water vapor, to elongate the life of the catalyst, and to lower the temperature (outlet temperature) of gas being discharged from the discharge pipe 43 of the reaction vessel 41 to not more than 250° C.

Namely, when the reformed gas containing hydrogen as a main component, and by-products such as carbon dioxide, carbon monoxide and water vapor is introduced via the gas-feeding pipe 42 shown in FIG. 3 into the reaction vessel 41, the catalyst existing closer to the gas-feeding pipe 42 is increasingly subjected to the heat to be generated from the reaction between carbon monoxide and water vapor, and the concentration of carbon monoxide would become gradually lower as it is located closer to the discharge pipe 43, and hence the exothermic temperature would become lowered proportionately.

As shown in FIG. 3, when the carbon monoxide transforming apparatus is constructed such that the space inside the reaction vessel 41 is horizontally partitioned by making use of a plurality of perforated plates 44₁ to 44₇, and at the same time, the catalyst 45 and the cooling coils 46₁ to 46₃ are alternately arranged in these partitioned spaces under the aforementioned exothermic conditions on the occasion of the transformation operation, it is possible to cool the catalyst 45 in the catalyst-filling zones by each of the cooling coils 46₁ to 46₃ in conformity with the magnitude of exothermic temperature of the catalyst-filling zones which are respectively located next to these cooling coils 46₁ to 46₃. As a result, each catalyst-filling zone can be controlled to a suitable temperature, thereby making it possible to execute a more effective transforming reaction between carbon monoxide and water vapor, and to further elongate the life of catalyst. Moreover, it is possible to lower the temperature (outlet temperature) of gas being discharged from the discharge pipe 43 of the reaction vessel 41 to not more than 250° C. In particular, the cooling rate by each of these cooling coils 46₁ to 46₃ can be adjusted by suitably changing the temperature or flow rate of the cooling medium, thereby enabling the temperature of each catalyst-filling zone to be more suitably controlled.

Further, as shown in FIG. 4, when the carbon monoxide transforming apparatus is constructed such that the space inside the reaction vessel 41 is horizontally partitioned by making use of six perforated plates 44₁ to 44₆ that the catalyst 45 and the cooling coils 46₁ and 46₂ are separately arranged in these partitioned spaces, and that the catalyst 45 and the cooling coils 46₃ are coexisted in the partitioned space in the vicinity of the discharge pipe 43 where the exothermic reaction is rather slow, it is possible to cool the catalyst 45 in the catalyst-filling zones by each of the cooling coils 46₁ to 46₃ in conformity with the magnitude of exothermic temperature of the catalyst-filling zones. As a result, each catalyst-filling zone can be controlled to a suitable temperature, thereby making it possible to execute a more effective transforming reaction between carbon monoxide and water vapor, and to further elongate the life of catalyst. Moreover, it is possible to lower the temperature (outlet temperature) of gas being discharged from the discharge pipe 43 of the reaction vessel 41 to not more than 250° C. Additionally, since the catalyst 45 and the cooling coils 46₃ are coexisted in the partitioned space in the vicinity of the discharge pipe 43 of the reaction vessel 41, it is possible to miniaturize the carbon monoxide transforming apparatus as compared with the carbon monoxide transforming apparatus shown in FIG. 3.

On the other hand, it is generally impossible, during the suspension of operation of the fuel cell power generating system, to prevent the reverse flow of air that has been once discharged out of the gas discharge port. In the case of the stationary fuel cell power generating system to be employed as a distributed power source, it is possible to alleviate the reverse flow of air by means of purging using an inert gas. In the case of onboard type fuel cell power generating system however, it would be unrealistic to mount a cylinder, etc. on a vehicle for the purpose of purging by an inert gas. Furthermore, irrespective of the stationary or onboard type system, the execution of instantaneous power generation would be obstructed if the purging using an inert gas is to be performed every time of start-up/stoppage.

According to the carbon monoxide transforming apparatus 40 to be incorporated into the fuel cell power generating system of this invention which is shown in FIG. 1, the oxidation of catalyst due to the exposure thereof to air atmosphere can be inhibited or prevented, and still more, a catalyst excellent in oxidation resistance and in heat resistance is filled in the reaction vessel, so that the concentration of carbon monoxide can be effectively reduced through the reaction (transformation) between carbon monoxide and water vapor for a long period of time, and at the same time, the start-up of the apparatus 40 can be instantaneously performed. As a result, without necessitating the purging by way of inert gas on the occasion of re-start-up after the suspension of the fuel cell 60 disposed on the downstream side of the carbon monoxide transforming apparatus 40, the carbon monoxide transforming apparatus 40 can be instantaneously started to thereby reduce carbon monoxide which obstructs the electrochemical reaction of hydrogen-oxygen, and at the same time, a gas (hydrogen-rich gas for fuel electrode) containing a large quantity of hydrogen increased in proportion to the reduction of carbon monoxide can be generated and introduced into the fuel electrode 62 of the fuel cell 60. Therefore, it is now possible to realize a fuel cell system which is capable of performing an effective and instantaneous power generation and is useful as a power source for use in home or vehicle.

Further, when the carbon monoxide-selective oxidizing device 50 for selectively oxidizing carbon monoxide in the reformed gas to be discharged from the carbon monoxide transforming apparatus 40 is interposed between the carbon monoxide transforming apparatus 40 and the solid polymer type fuel cell 60, it becomes possible to introduce a hydrogen-rich gas having a further reduced concentration of carbon monoxide into the fuel electrode 62 of the fuel cell 60, thereby making it possible to perform a further effective and smooth power generation.

Next, preferable examples of this invention will be explained.

### EXAMPLE 1

First of all, titanium oxide powder and a hydrocarbon (binder) (both available in the market) were introduced into a granulating machine to granulate the mixture into a spherical porous body having a diameter of 3 to 4 mm, thereby manufacturing a carrier. Then, a predetermined quantity of aqueous solution of platinic chloride was impregnated into the aforementioned carrier, dried at a temperature of about 120° C., and sintered in air atmosphere at a temperature of 500° C. Thereafter, the resultant body was subjected to a reduction treatment for 4 hours in a reducing atmosphere containing hydrogen at a temperature of 400° C., thereby manufacturing a catalyst (Pt/TiO₂-based catalyst) having a composition shown in the following Table 1.

### EXAMPLE 2

First of all, a titanium oxide carrier manufactured in the same manner as in Example 1 was impregnated with a predetermined quantity of aqueous solution of cerium nitrate and then with a predetermined quantity of aqueous solution of platinic chloride. The resultant body was then dried at a temperature of about 120° C., and sintered in air atmosphere at a temperature of 500° C. Thereafter, the resultant body was subjected to a reduction treatment for 4 hours in a reducing atmosphere containing hydrogen at a temperature of 400° C., thereby manufacturing a catalyst (P—CeO₂/TiO₂-based catalyst) having a composition shown in the following Table 1.

### EXAMPLES 3 AND 4

First of all, a titanium oxide carrier manufactured in the same manner as in Example 1 was impregnated with a predetermined quantity of aqueous solution of cerium nitrate, with a predetermined quantity of aqueous solution of lanthanum nitrate, and with a predetermined quantity of aqueous solution of platinic chloride in the mentioned order. The resultant body was then dried at a temperature of about 120° C., and sintered in air atmosphere at a temperature of 500° C. Thereafter, the resultant body was subjected to a reduction treatment for 4 hours in a reducing atmosphere containing hydrogen at a temperature of 400° C., thereby manufacturing two kinds of catalysts (Pt—CeO₂—La₂O₃/TiO₂-based catalyst) having a composition shown in the following Table 1.

### EXAMPLE 5

First of all, a titanium oxide carrier manufactured in the same manner as in Example 1 was impregnated with a predetermined quantity of aqueous solution of palladium chloride. The resultant body was then dried at a temperature of about 120° C., and sintered in air atmosphere at a temperature of 500° C. There-after, the resultant body was subjected to a reduction treatment for 4 hours in a reducing atmosphere containing hydrogen at a temperature of 500° C., thereby manufacturing a catalyst (Pd/TiO₂-based catalyst) having a composition shown in the following Table 1.

### EXAMPLE 6

First of all, zinc oxide powder and a hydrocarbon (binder) (both available in the market) were introduced into a granulating machine to granulate the mixture into a spherical porous body having a diameter of 3 to 4 mm, thereby manufacturing a carrier. Then, a predetermined quantity of aqueous solution of palladium chloride was impregnated into the aforementioned carrier, dried at a temperature of about 120° C., and sintered in air atmosphere at a temperature of 500° C. Thereafter, the resultant body was subjected to a reduction treatment for 4 hours in a reducing atmosphere containing hydrogen at a temperature of 500° C., thereby manufacturing a catalyst (Pd/ZnO-based catalyst) having a composition shown in the following Table 1.

### EXAMPLE 7

First of all, iron oxide powder and a hydrocarbon (binder) (both available in the market) were introduced into a granulating machine to granulate the mixture into a spherical porous body having a diameter of 3 to 4 mm, thereby manufacturing a carrier. Then, the carrier was impregnated with a predetermined quantity of aqueous solution of cerium nitrate, with a predetermined quantity of aqueous solution of lanthanum nitrate, and with a predetermined quantity of aqueous solution of palladium chloride in the mentioned order. The resultant body was then dried at a temperature of about 120° C., and sintered in air atmosphere at a temperature of 500° C. Thereafter, the resultant body was subjected to a reduction treatment for 4 hours in a reducing atmosphere containing hydrogen at a temperature of 500° C., thereby manufacturing a catalyst (Pd—CeO₂—La₂O₃/Fe₂O₃-based catalyst) having a composition shown in the following Table 1.

100 mL of each of the catalysts obtained in Examples 1 to 7 was respectively charged into the reaction vessel 41 of the carbon monoxide transforming apparatus shown in FIG. 2, and a reformed simulation gas having a temperature as shown in the following Table 1 was introduced from the gas-feeding pipe 42 into the reaction vessel 41 at a flow rate of 200 L/hr. Then, the concentration of CO being discharged from the gas discharge pipe 43 (outlet) of the reaction vessel 41 was measured. The composition of the reformed simulation gas was hydrogen gas 45%, carbon dioxide 10%, CO 7%, nitrogen gas 20% and the balance of water vapor.

On the other hand, experiments were performed in the same manner as explained above except that a spherical copper-zinc-based catalyst having a diameter of 3 to 4 mm (available in the market) was charged into the reaction vessel 41 shown in FIG. 2, and that two kinds of reformed simulation gases having temperatures of 200° C. or 350° C. were respectively introduced from the gas-feeding pipe 42 into the reaction vessel 41. Then, the concentration of CO being discharged from the outlet of the reaction vessel 41 was measured. These experiments are referred to herein as Comparative Example 1 (the inlet temperature of the reformed simulation gas: 200° C.) and as Comparative Example 2 (the inlet temperature of the reformed simulation gas: 350° C.), respectively.

The results are shown in the following Table 1.

TABLE 1

| | | Temperature of | | | | |
|---|---|---|---|---|---|---|
| | | catalyst layer | | Outlet CO | | |
| | | (° C.) | | concentration* | | |
| | Composition of catalyst | Inlet | Outlet | (1) | (2) | (3) |
| Example 1 | 0.3%Pt/TiO₂ (carrier) | 300 | 250 | 0.51 | 0.52 | 0.51 |
| Example 2 | 0.1%Pt—1.0%CeO₂/TiO₂ (carrier) | 350 | 250 | 0.63 | 0.65 | 0.63 |
| Example 3 | 0.3%Pt—0.5%CeO₂—0.5%La₂O₃/TiO₂ (carrier) | 250 | 250 | 0.42 | 0.43 | 0.42 |
| Example 4 | 1.0%Pt—1.0%CeO₂—1.0%La₂O₃/TiO₂ (carrier) | 250 | 250 | 0.40 | 0.40 | 0.40 |
| Example 5 | 1.0%Pd/TiO₂ (carrier) | 300 | 250 | 0.55 | 0.60 | 0.55 |
| Example 6 | 1.0%Pd/ZnO (carrier) | 250 | 250 | 0.45 | 0.48 | 0.45 |
| Example 7 | 1.0%Pd—0.5%CeO₂/Fe₂O₃ (carrier) | 300 | 250 | 0.50 | 0.57 | 0.50 |
| Comparative | 25%Cu—40%ZnO—35%Al₂O₃ (carrier) | 200 | 250 | 0.40 | 1.5 | 0.40 |
| Example 1 | | | | | | |
| Comparative | 25%Cu—40%ZnO—35%Al₂O₃ (carrier) | 350 | 250 | 0.40 | 1.8 | 0.60 |
| Example 2 | | | | | | |

*The outlet concentration of CO (1) indicates the outlet concentration which was measured under the steady state wherein the catalyst was subjected to a reduction for 4 hours at a temperature of 250° C., and then, the catalyst layer was adjusted to a predetermined temperature, after which the reformed simulation gas was introduced into the reaction vessel.

The outlet concentration of CO (2) indicates the outlet concentration which was measured under the condition wherein after finishing the experiment under the steady state of the above (1), the feeding of the reformed simulation gas was suspended and the reaction vessel was allowed to cool as it was and left to stand for 24 hours, after which the catalyst layer was heated again up to a predetermined temperature and then the reformed simulation gas was again introduced into the reaction vessel, the measurement of the outlet concentration being executed 10 minutes after this re-introduction of the reformed simulation.

The outlet concentration of CO (3) indicates the outlet concentration which was measured 4 hours after the re-introduction of the reformed simulation after repeating the same procedures as explained in the above (2).

As apparently seen from the Table 1, in the case of the outlet concentration of CO (1), since the catalyst was allowed to react with the reformed simulation gas immediately after the four hours of reducing treatment thereof, the carbon monoxide transforming apparatus filled with any one of the catalysts of Examples 1 to 7 exhibited a CO concentration-reduction effect (the conversion ratio of producing H₂ and CO₂ from the reaction between CO and H₂O) which was the same with or slightly lower than that of the carbon monoxide transforming apparatus filled with any one of the catalysts of Comparative Examples 1 and 2.

On the other hand, when the catalytic activity was lowered by exposing the catalyst (by oxidizing the catalyst) after the reaction as in the case of the outlet concentration of CO (2), the carbon monoxide transforming apparatus filled with any one of the catalysts of Examples 1 to 7 was found to exhibit an extremely enhanced CO concentration-reduction effect as compared with that of the carbon monoxide transforming apparatus filled with any one of the catalysts of Comparative Examples 1 and 2. This phenomenon can be attributed to the fact that the catalysts of Examples 1 to 7 could not be oxidized even if they were exposed to air atmosphere, and hence the reduction operation of catalysts could be omitted. Therefore, it will be recognized that according to the carbon monoxide transforming apparatus filled with any one of the catalysts of Examples 1 to 7, the start-up thereof can be facilitated, and the CO concentration can be instantaneously reduced. Whereas in the case of Comparative Example 1, since the catalyst thereof is partially oxidized, the carbon monoxide transforming apparatus filled with this catalyst is required to undergo the reducing operation of catalyst, thus prolonging the start-up time and making it difficult to execute an instantaneous start-up of the apparatus.

Further, since the catalysts of Examples 1 to 7 are excellent in heat resistance, the carbon monoxide transforming apparatus filled with any one of the catalysts of Examples 1 to 7 is enabled to perform a high-temperature running. As a result, the range of operation temperature can be expanded, and the apparatus can be miniaturized. Whereas in the case of the catalyst of Comparative Example 2, since the heat resistance thereof is insufficient, the concentration of CO in the steady state subsequent to the restart-up is caused to increase if the inlet temperature is 350° C.

By the way, when the concentration of CO is measured after the reformed gas is subjected to the reaction in a hydrogen atmosphere for four hours as in the case of the outlet concentration of CO (3), the catalytic activity of the catalyst can be gradually enhanced during a period of four hours in which the catalyst is exposed to the hydrogen atmosphere. Therefore, the concentration of CO to be obtained by the carbon monoxide transforming apparatus wherein any one of the catalysts of Examples 1 to 7 as well as of Comparative Examples 1 and 2 is filled would indicate almost the same tendency as in the case of the outlet concentration of CO (1).

### EXAMPLE 8 AND COMPARATIVE EXAMPLE 3

100 mL of the same catalyst (Pt/TiO₂-based catalyst) as obtained in Example 2 and the same catalyst (Cu—ZnO/Al₂O₃-based catalyst) as obtained in Comparative Example 1 were respectively charged into the reaction vessel 41 of the carbon monoxide transforming apparatus shown in FIG. 2, and a reformed simulation gas having a composition consisting of hydrogen gas 45%, carbon dioxide 10%, CO 7%, nitrogen gas 20% and the balance of water vapor was continuously introduced at a flow rate of 200 L/hr from the gas-feeding pipe 42 into the reaction vessel 41 under the conditions of 300° C. in inlet temperature and 250° C. in outlet temperature. Then, the concentration of CO being discharged from the gas discharge pipe 43 (outlet) of the reaction vessel 41 was measured every predetermined time (seconds). The results are shown in FIG. 5.

As shown in FIG. 5, in the case of the carbon monoxide transforming apparatus of Comparative Example 3 which was filled with the Cu—ZnO/Al₂O₃-based catalyst, it required a period of as long as about 5,000 seconds for realizing approximately 100% conversion ratio of carbon monoxide. Whereas, in the case of the carbon monoxide transforming apparatus of Example 8 which was filled with the Pt/TiO₂-based catalyst, it required a period of about 9 seconds for realizing approximately 100% conversion ratio of carbon monoxide, thus demonstrating the possibility of instantaneous start-up.

### EXAMPLES 9 AND 10 AND COMPARATIVE EXAMPLE 4

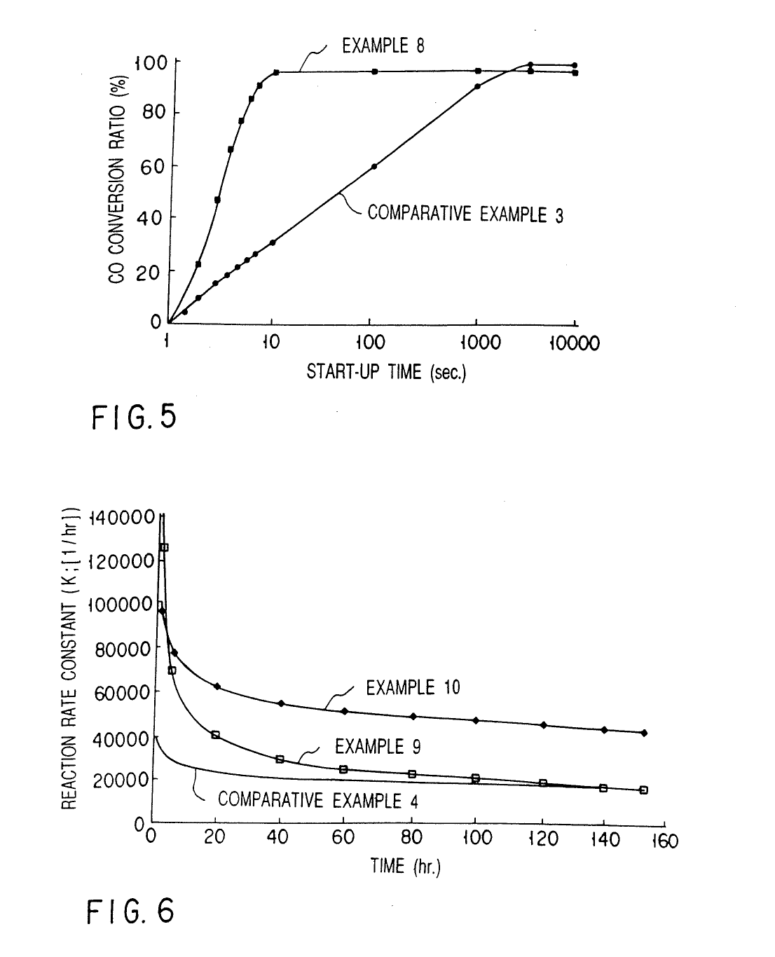

100 mL of the same catalyst (Pt/TiO₂-based catalyst) as obtained in Example 2, the same catalyst (Pt—CeO₂/TiO₂-based catalyst) as obtained in Example 3 and the same catalyst (Cu—ZnO/Al₂O₃-based catalyst) as obtained in Comparative Example 1 were respectively charged into the reaction vessel 41 of the carbon monoxide transforming apparatus shown in FIG. 2, and a reformed simulation gas having a composition consisting of hydrogen gas 45%, carbon dioxide 10%, CO 7%, nitrogen gas 20% and the balance of water vapor was continuously introduced at a flow rate of 200 L/hr from the gas-feeding pipe 42 into the reaction vessel 41 under the conditions of 300° C. in inlet temperature and 250° C. in outlet temperature. Then, the concentration of CO being discharged from the gas discharge pipe 43 (outlet) of the reaction vessel 41 was measured every predetermined time (hours), thereby determining the reaction rate constant (k) as a criterion indicating the activity of each catalyst. The results are shown in FIG. 6.

As shown in FIG. 6, the carbon monoxide transforming apparatus of Example 9 where the Pt/TiO₂-based catalyst was filled therein indicated a high reaction rate constant for a period of 120 hours starting from the initial stage of transformation treatment as compared with the carbon monoxide transforming apparatus of Comparative Example 4 where the Cu—ZnO/Al₂O₃-based catalyst was filled therein, thus demonstrating that the Pt/TiO₂-based catalyst is capable of exhibiting an excellent catalytic activity for a long period of time.

Further, the carbon monoxide transforming apparatus of Example 10 where the Pt—CeO₂/TiO₂-based catalyst was filled therein indicated a still higher reaction rate constant as compared not only with the carbon monoxide transforming apparatus of Comparative Example 4 where the Cu—ZnO/Al₂O₃; -based catalyst was filled therein but also with the carbon monoxide transforming apparatus of Example 9 where the Pt/TiO₂-based catalyst was filled therein, thus demonstrating that the Pt—CeO₂/TiO₂-based catalyst is capable of exhibiting an extremely excellent catalytic activity for a long period of time.

As explained above, it is possible, according to this invention, to provide a carbon monoxide transforming apparatus which is suited for use in a fuel cell to be subjected to frequent start-up/stoppage operations and is capable of instantaneously performing a transformation and start-up operation on the occasion of transforming a gas containing, as main components, hydrogen, carbon monoxide, carbon dioxide and water vapor so as to convert the carbon monoxide into carbon dioxide and at the same time to generate hydrogen, and also capable of operating it at an expanded range of temperature.

It is possible, according to this invention, to provide a fuel cell power generating system which is useful as a power source for use in home or vehicle, and provided with a transforming apparatus which is capable of instantaneously performing a transformation and start-up operation on the occasion of transforming a gas containing, as main components, hydrogen, carbon monoxide, carbon dioxide and water vapor so as to convert the carbon monoxide into carbon dioxide and at the same time to generate hydrogen, and also capable of operating it at an expanded range of temperature, thereby enabling the fuel cell power generating system to be effectively and instantaneously operated by preventing an electrochemical reaction between hydrogen and oxygen from being obstructed by the carbon monoxide.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1-11. (canceled)

12. A fuel cell power generating system comprising:
a reformer for converting a raw fuel into a hydrogen-rich reformed gas;
a fuel cell including a fuel electrode; and
a carbon monoxide transforming apparatus disposed between the reformer and the fuel cell, including a reaction vessel including gas inlet and outlet ports, and a catalyst for transforming the carbon monoxide in the reformed gas to carbon dioxide, and which is filled in the reaction vessel and includes platinum carried on a carrier that is formed of titanium oxide,
wherein the gas inlet port of the reaction vessel is connected to the reformer, and a reformed gas is introduced from the reformer and supplied to the vessel through the gas inlet port, and
the gas outlet port of the reaction vessel is connected to the fuel cell, and a transformed gas is exhausted from the reaction vessel to the fuel cell through the gas outlet port.

13. The fuel cell power generating system according to claim 12, wherein a desulfurizer is further disposed on an upstream side of said reformer.

14. The fuel cell power generating system according to claim 12, wherein a selective oxidizing means for selectively oxidizing carbon monoxide in the transformed gas fed from said transforming apparatus is further disposed between said transforming apparatus and said fuel cell.

15. The fuel cell power generating system according to claim 12, wherein a rare earth element is further carried on the carrier.

16. The fuel cell power generating system according to claim 15, wherein platinum and the rare earth element are carried on the titanium oxide carrier at a ratio of 0.1 to 3% by weight and 0.3 to 3% by weight, respectively.

17. The fuel cell power generating system according to claim 15, wherein the rare earth element is at least one element selected from the group consisting of lanthanum and cerium.

18. A fuel cell power generating system comprising:
a reformer for converting a raw fuel into a hydrogen-rich reformed gas;
a fuel cell; and
a carbon monoxide transforming apparatus disposed between the reformer and the fuel cell, including a reaction vessel including gas inlet and outlet ports, and a catalyst for transforming the carbon monoxide in the reformed gas to carbon dioxide, and which is filled in the reaction vessel and includes palladium carried on a carrier that is formed of zinc oxide,
wherein the gas inlet port of the reaction vessel is connected to the reformer, and a reformed gas is introduced from the reformer and supplied to the vessel through the gas inlet port, and
the gas outlet port of the reaction vessel is connected to the fuel cell, and a transformed gas is exhausted from the reaction vessel to the fuel cell through the gas outlet port.

19. The fuel cell power generating system according to claim 18, wherein a desulfurizer is further disposed on an upstream side of the reformer.

20. The fuel cell power generating system according to claim 18, wherein a selective oxidizing means for selectively oxidizing carbon monoxide in the transformed gas fed from the transforming apparatus is further disposed between the transforming apparatus and the fuel cell.

21. A fuel cell power generating system comprising:
a reformer for converting a raw fuel into a hydrogen-rich reformed gas;
a fuel cell; and
a carbon monoxide transforming apparatus disposed between the reformer and the fuel cell, including a reaction vessel including gas inlet and outlet ports, and a catalyst for transforming the carbon monoxide in the reformed gas to carbon dioxide and that is filled in the reaction vessel and includes palladium and a rear earth element carried on a carrier that is formed of iron oxide,
wherein the gas inlet portion of the reaction vessel is connected to the reformer, and a reformed gas is introduced from the reformer and supplied to the vessel through the gas inlet port, and
the gas outlet port of the reaction vessel is connected to the fuel cell, and a transformed gas is exhausted from the reaction vessel to the fuel cell through the gas outlet port.

22. The fuel cell power generating system according to claim 21, wherein the rare earth element is at least one element selected from the group consisting of lanthanum and cerium.

23. The fuel cell power generating system according to claim 21, wherein palladium and the rare earth element are carried on the iron oxide carrier at a ratio of 0.5 to 5% by weight and 1 to 3% by weight, respectively.

24. The fuel cell power generating system according to claim 21, wherein a desulfurizer is further disposed on an upstream side of the reformer.

25. The fuel cell power generating system according to claim 21, wherein a selective oxidizing means for selectively oxidizing carbon monoxide in the transformed gas fed from the transforming apparatus is further disposed between the carbon monoxide transforming apparatus and the fuel cell.

26. A fuel cell power generating system comprising:
a reformer for converting a raw fuel into a hydrogen-rich reformed gas;
a carbon monoxide transforming apparatus including a reaction vessel including gas inlet and outlet ports, the reformed gas being introduced through the gas inlet port, and a transformed gas being exhausted through the outlet port, and a catalyst filled in the reaction vessel and including at least platinum or palladium carried on a carrier that has a base point on the surface thereof;
a cooling coil for cooling the catalyst disposed inside the reaction vessel; and
a fuel cell having a fuel electrode into which the transformed gas is introduced from the transforming apparatus.

27. The fuel cell power generating system according to claim 26, wherein a desulfurizer is further disposed on an upstream side of the reformer.

28. The fuel cell power generating system according to claim 26, wherein a selective oxidizing means for selectively oxidizing carbon monoxide in the transformed gas fed from the transforming apparatus is further disposed between the transforming apparatus and the fuel cell.

29. A fuel cell power generating system comprising:
a reformer for converting a raw fuel into a hydrogen-rich reformed gas;
a carbon monoxide transforming apparatus including a reaction vessel including gas inlet and outlet ports, the reformed gas being introduced through the gas inlet port, and a transformed gas being exhausted through the outlet port, and a catalyst filled in the reaction vessel and including at least platinum or palladium carried on a carrier that has a base point on the surface thereof; and
a fuel cell having a fuel electrode into which the transformed gas is introduced from the transforming apparatus,
wherein the reaction vessel in the transforming apparatus is partitioned by a plurality of gas-permeating plates into plural sections that are arranged between the gas inlet port and the gas outlet port, each section housing the catalyst or a cooling coil, which are alternately arranged.

30. The fuel cell power generating system according to claim 29, wherein a desulfurizer is further disposed on an upstream side of the reformer.

31. The fuel cell power generating system according to claim 29, wherein a selective oxidizing means for selectively oxidizing carbon monoxide in the transformed gas fed from the transforming apparatus is further disposed between the transforming apparatus and the fuel cell.

32. A fuel cell power generating system comprising:
a reformer for converting a raw fuel into a hydrogen-rich reformed gas;
a carbon monoxide transforming apparatus including a reaction vessel including gas inlet and outlet ports, the reformed gas being introduced through the gas inlet port, and a transformed gas being exhausted through the outlet port, and a catalyst filled in the reaction vessel and including at least platinum or palladium carried on a carrier that has a base point on the surface thereof;
a cooling means for cooling the catalyst disposed inside the reaction vessel; and
a fuel cell having a fuel electrode into which the transformed gas is introduced from the transforming apparatus.

33. The fuel cell power generating system according to claim 32, wherein a desulfurizer is further disposed on an upstream side of the reformer.

34. The fuel cell power generating system according to claim 44, wherein a selective oxidizing means for selectively oxidizing carbon monoxide in the transformed gas fed from the transforming apparatus is further disposed between the transforming apparatus and the fuel cell.
